(19) United States
(12) Patent Application Publication
(10) Pub. No.: US 2006/0173824 A1
(43) Pub. Date: Aug. 3, 2006

(54) Electronic communication analysis and visualization

(75) Inventors: Andrew Bensky, Scotts Valley, CA (US); Richard Ling, Palo Alto, CA (US); Ed Miller, Palo Alto, CA (US); Anesh Madapoosi, Sunnyvale, CA (US); Frederick Mueller, Los Altos Hills, CA (US); Drew Stoddard, Sandy, UT (US)

Correspondence Address: NORTH WEBER & BAUGH LLP, 2479 E. BAYSHORE ROAD, SUITE 707, PALO ALTO, CA, 94303, US

(73) Assignee: MetaLINCS Corporation

(21) Appl. No.: 11/082,038

(22) Filed: Mar. 15, 2005

Related U.S. Application Data
(60) Provisional application No. 60/649,395, filed on Feb. 1, 2005.

(51) Int. Cl. G06F 17/30; G06F 7/00

(52) U.S. Cl. 707/3

(57) ABSTRACT

An electronic communication analysis and visualization tool that provides a user interface that displays various attributes of electronic communication and any analysis thereof. The tool includes visualization of electronic messages, people associated with electronic communication, electronic communication threads, and concepts associated with electronic communication. The tool may further integrate and display attributes of electronic communication that are derived from a particular electronic communication or a secondary source.

### CROSS REFERENCE TO RELATED PATENT APPLICATIONS

This application claims priority to U.S. Provisional Application No. 60/649,395, filed Feb. 1, 2005, which application is incorporated herein by reference in its entirety.

### BACKGROUND

A. Technical Field

The present invention relates generally to a display for an electronic communication search and analysis tool, and more particularly, to a user controlled display of data, related to a search query of electronic communications, which is merged into a platform to allow various perspective levels of attributes associated with electronic communications.

B. Background of the Invention

The importance of electronic communication in all aspects of society is well known. Over the past decade, the use of electronic communications has become woven into the way individuals communicate and otherwise provide information to each other. The use of electronic media, such as email platforms, provides a person an easy method for sharing large amounts of data with numerous individuals. Additionally, the ability to attach large documents to emails and other types of electronic communications further enhances the ability of these communications to proliferate large amounts of data.

The development and use of electronic communication media has been both a blessing and a burden to business entities. Companies, and their employees, are now able to much more effectively communicate internally using various forms of electronic communications. Furthermore, companies are able to efficiently respond to customer requests and provide information to various external entities. However, the use of electronic communications also offers a media in which large amounts of confidential information may be secretly communicated outside of the company. In addition, employee efficiency may also be reduced as employees use electronic communications, such as instant messaging and short message service applications, to communicate with acquaintances instead of attending to employment obligations. Furthermore, an archive of electronic communications provides a company a historical record of communications within the company and is considered a valuable corporate asset.

Companies may attempt to analyze, or otherwise monitor, electronic communications in an attempt to prevent inappropriate or illegal use of these electronic media. Electronic communications, and in particular email, provide evidentiary importance, and may be an effective investigative tool in both legal and non-legal matters. Effective analysis of electronic communication presents numerous difficulties to any company. First, as the features and efficiency of electronic communications have increased, so has the use of these media by individuals. Thus, a large company may have tens of thousands, if not hundreds of thousands, of electronic communications transmitted in a short period of time. Second, electronic communications, by themselves, may not provide sufficient information to enable an effective analysis of the communication. For example, information about a participant in electronic communication may not be fully retrieved from the electronic communication itself. Additionally, the electronic communication may not provide sufficient context to enable efficient analysis of the content therein.

Current analysis tools do not provide effective means for analyzing large amounts of electronic data. These analysis tools fail to integrate important characteristics of electronic communication within their analysis platforms. Some of these characteristics of electronic communication may not be directly obtained from a piece of electronic communication but require the use of other sources. Furthermore, as large amounts of electronic communications are to be analyzed, these analysis tools fail to provide filtering functionality that enable a user to effectively investigate large quantity of electronic communications at various levels of granularity.

Another deficiency of current analysis tools is to provide a user a multi-level display of characteristics associated with electronic communications. This deficiency results in further complicating a daunting task of analyzing a very large amount of electronic communications relative to whatever search parameters are necessary to the particular analysis.

### SUMMARY OF THE INVENTION

The present invention provides an analysis and visualization of electronic communications. The electronic communications may include electronic mail and messages, instant message, SMS, voice and video data. According to one embodiment of the invention, an acquired electronic communication is associated with information retrieved from a source other than the communication, such as a company user directory, and provided to a user in a display. This association allows a visualization that allows a user to more easily analyze and view information describing threads, concepts, time, participants, and content that are related to a particular electronic communication.

This analysis and display of these various electronic communication attributes is provided to a user in a structured format that allows drill-down on a particular attribute(s). In one embodiment of the invention, a user is provided information and attributes related to a particular electronic communication. The user is able to retrieve additional information or receive further analysis of a particular communication attribute by clicking on an icon or button.

In yet another embodiment, a user is provided information and attributes related to a thread(s) containing multiple electronic communications. A user may drill-down on a thread to further analyze attributes related to the thread or related thread.

In yet another embodiment, a user is provided information and attributes related to a person associated with an electronic communication. A user may drill-down on the person to further analyze attributes related to the person or electronic communications related to the person.

In still yet another embodiment, a user is provided information and attributes related to a concept associated with an electronic communication(s). A user may drill-down on the concept to further analyze attributes related to the concept itself, people associated with the concept, or electronic communications associated with the concept.

One skilled in the art will recognize that numerous different types of information may be associated with an electronic communication and used in an analysis of the electronic communication.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is an illustration of an electronic communication search and analysis display output according to one embodiment of the present invention.

FIG. 2A is an illustration of an electronic communication search and analysis bookmark architecture according to one embodiment of the present invention.

FIG. 2B is an illustration of an electronic communication search and analysis dynamic directory according to one embodiment of the present invention.

FIG. 2C is an illustration of an electronic communication search and analysis related concepts display according to one embodiment of the present invention.

FIG. 2D is an illustration of an electronic communication search and analysis history display according to one embodiment of the present invention.

FIG. 3 is an illustration of an electronic communication messages tab view according to one embodiment of the present invention.

FIG. 4 is an illustration of an electronic communication message view according to one embodiment of the present invention.

FIG. 5 is an illustration of an electronic communication threads tab view according to one embodiment of the present invention.

FIG. 6 is an illustration of an electronic communication thread view according to one embodiment of the present invention.

FIG. 7 is an illustration of a first electronic communication thread analysis display according to one embodiment of the present invention.

FIG. 7B is an illustration of a second electronic communication thread analysis display according to one embodiment of the present invention.

FIG. 8 is an illustration of an electronic communication people tab view according to one embodiment of the present invention.

FIG. 9 is an illustration of an electronic communication person view according to one embodiment of the present invention.

FIG. 10 is an illustration of an electronic communication “Received” tab display according to one embodiment of the present invention.

FIG. 11 is an illustration of an electronic communication “Sent” tab display according to one embodiment of the present invention.

FIG. 12 is an illustration of an electronic communication people chart display according to one embodiment of the present invention.

FIG. 13 is an illustration of an electronic communication concepts tab view according to one embodiment of the present invention.

FIG. 14A is an illustration of a first electronic communication concepts analysis display according to one embodiment of the present invention.

FIG. 14B is an illustration of a second electronic communication concepts analysis display according to one embodiment of the present invention.

### DETAILED DESCRIPTION OF THE PREFERRED EMBODIMENTS

An apparatus and method for displaying an electronic communications analysis and associated data thereof is described. The present invention is related to a platform that efficiently displays data associated with electronic communications, including data about the contents of a communication, the participants in a communication, a thread(s) associated with a communication, concept(s) associated with a communication, and time related to a communication. Electronic communications should be construed in its broadest sense and includes such communications as e-mail, instant messaging, short message service (“SMS”), voice, and video. In one embodiment of the invention, a display communicates data, associated with an electronic communication, using an interface that integrates data obtained directly from an electronic communication and data retrieved from a secondary source, such as a user directory. The integration of these different data sets and analysis tools into a single platform allows a user to more effectively analyze large amounts of electronic communication.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different devices including computer monitors, personal digital assistant displays, presentation displays and other related displays. The embodiments of the present invention may also be present in software, hardware or firmware. Structures and devices shown below in block diagram are illustrative of exemplary embodiments of the invention and are meant to avoid obscuring the invention.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. System Overview

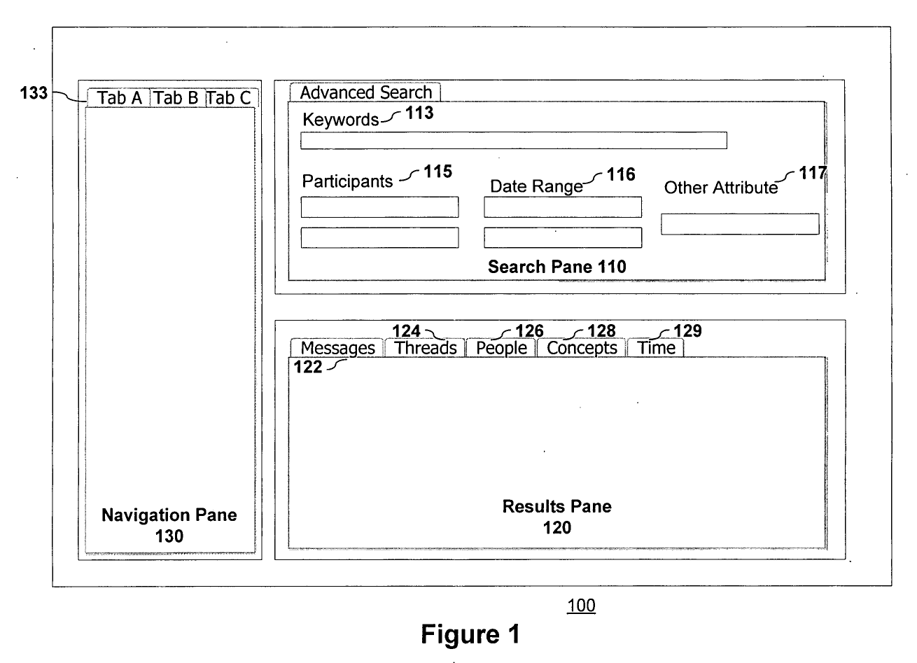

FIG. 1 illustrates a display 100, according to an embodiment of the invention, which supports navigation and searching functionality of data associated with electronic communications, and an interface to provide the results of this functionality to a user. This display 100 contains three separate display panes: a navigation pane 130, a search pane 110 and a results pane 120. This display 100 allows a user to perform search queries, view search results, activate various analysis tools, and save and organize search queries, search results, analysis of data, and other types of data. The display 100 offers a user these functions on a single platform, which allows a user to more effectively analyze and view electronic communications and secondary source data associated with the electronic communications. The present invention is not limited to this particular use of frames or windows within the display 100, but is intended to include all display devices, systems and methods in which this data may be provided to a user.

The navigation pane 130 may include a plurality of tabs 133 in which a user may toggle between various navigation functions such as bookmarks, directories, search-related concepts, search histories, and other such functions. Examples of these navigation functions shall be provided in more detail below. The navigation pane 130 allows a user to organize search queries, search results, group related concepts, and maintain other data. The navigation pane 130 categorizes and organizes the results, provide a user with an overall view of the result set as a whole, which may include automatically identifying important shared attributes of subsets of the result set, and also allow drill-down functionality into these related subsets.

The search pane 110 may include a keyword search 113, electronic communication participants search 115, electronic communication date range search 116, and other types of search 117 functionality related to an attribute of electronic communication including attributes such as searches of attachment titles, content, concepts, encrypted messages, messages with attachments of a certain type, or messages in a thread involving a certain set of participants or a certain concept. In general, any combination of content and contextual factors that were gathered from input sources (e.g., messages, people directory, etc.) may be searched. Directory derived metadata such as mailing lists, departments, organizations, companies, alternate names and email addresses may also be searched. A user may search electronic communications, and data associated therewith, using these searches or refine a pre-existing search query.

The results pane 120 allows a user to view a result(s) from a search query and perform various analysis functions on the search results. The results pane 120 includes multiple tabs corresponding to the display of different types of data and analysis thereof. For example, the results pane may include a messages tab 122, a threads tab 124, a people tab 126, a concepts tab 128, a time tab 129 or combination of these tabs. The features associated with each of these tabs will be described in detail below. The results pane 120 allows a user to toggle between a search result and various analyses performed on the search result.

B. Navigation Pane

According to one embodiment of the invention, the navigation pane 130 may include a bookmarks tab, a directory tab, a related concepts tab and a history tab. These tabs and associated functionality allow a user to save and organize search results, data associated with search results (such as specific queries), and analysis performed on the search results.

1. Bookmarks Tab

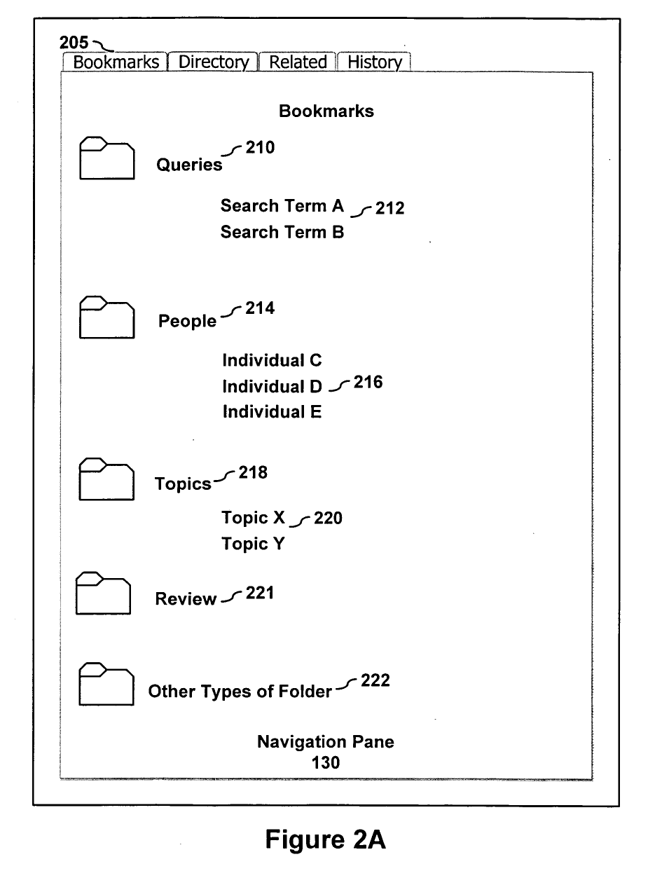

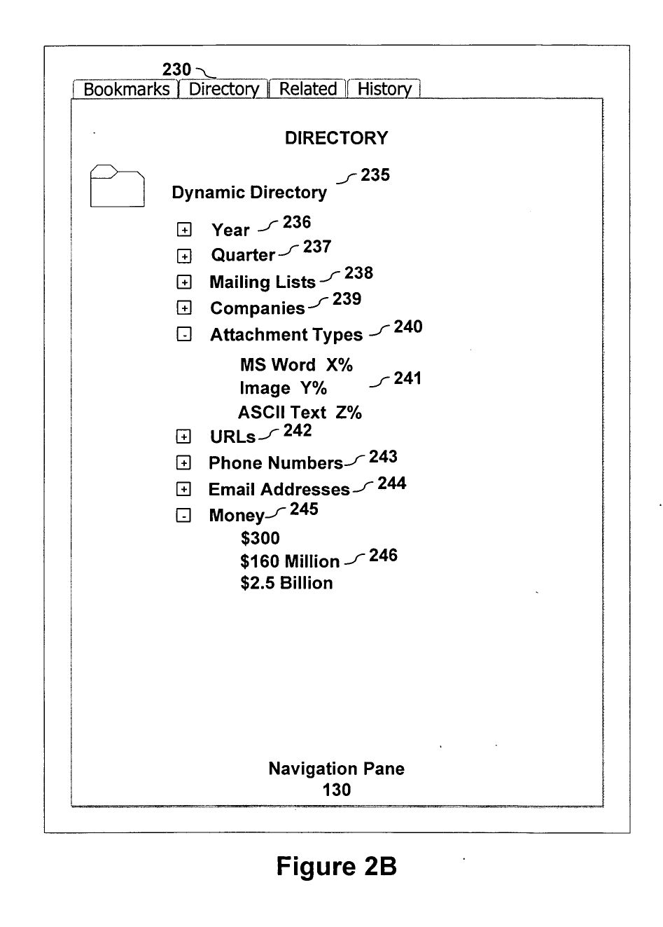

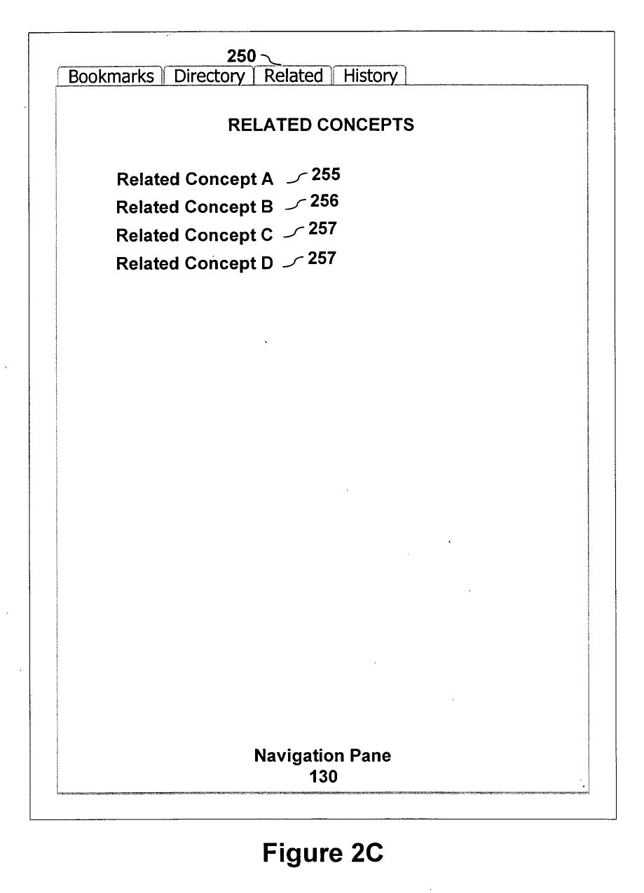

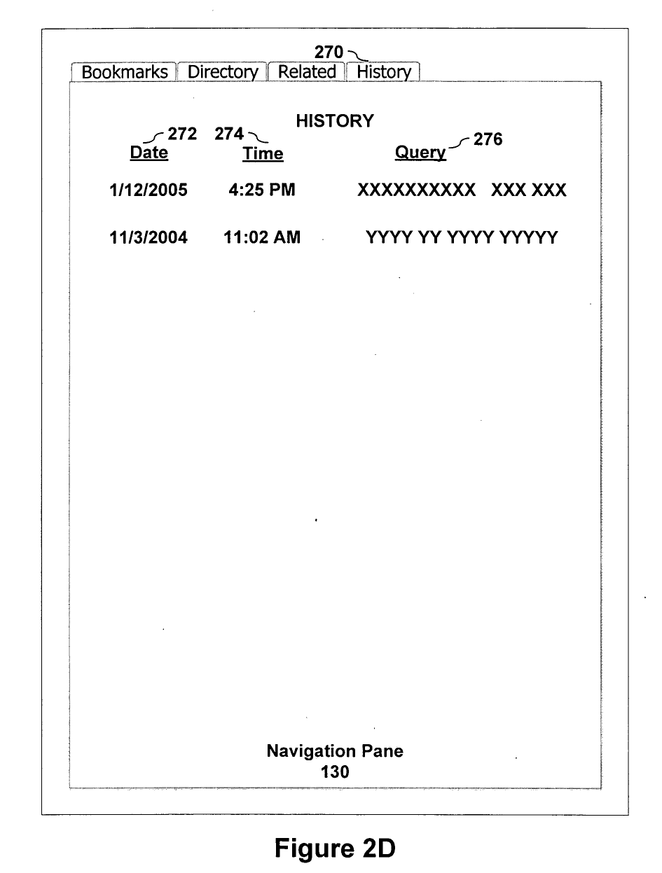

FIG. 2A is an illustration of a bookmarks tab 205 according to one embodiment of the invention. The bookmarks tab 205 may include multiple folders such as queries 210, people 214, topics 218, and other types of folders 222 in which bookmarks that reference an electronic communication or a corresponding analysis may be stored. Folders may be nested within other folders to create topical hierarchies. Additional features, such as drag and drop, may be provided to a user as an easy way in which to manage the bookmarks within the folders.

A queries folder 210 may be provided to enable a user to store search query terms and or phrases. In this particular illustration, the queries folder 210 contains a search term A and a search term B 212. This feature allows a user to save particular search terms/phrases that were used to generate particular desirable search results.

A people folder 214 may be provided to enable a user to store data related to people, such as individuals who participated in particular electronic communications. In this particular illustration, the people folder 214 contains three individuals C, D, and E 216. A user may click on one of these individuals to retrieve save information related to that particular individual.

A topics folder 218 may be provided to enable a user to store information related to a particular topic. In this particular illustration, the topics folder 218 includes information related to two topics, X and Y 220. A user may click on one of these topics to retrieve saved information related to the particular topic, such as various search results that were generated during an investigation or electronic communications having a particular attachment.

The navigation pane 130 may also have other types of folders. For example, review folders having messages that are suspicious or important and may need further review and events folders having messages and other information found to be relevant to a specific event may be included in the navigation pane. In general, the folders are used as organizational aids so that a user may organize various types of results from other features in the analysis application, and that these results may include data related to messages, threads, people, queries, and concepts.

2. Directory Tab

FIG. 2B illustrates a directory tab 230 according to one embodiment of the invention. The directory may include a number of different categories that are applied to messages in a search result list. In particular, the directory tab 230 may include a dynamic directory 235 in which a search result is filtered into categories and stored in folders according to this filtering process. This filtering process allows a user to see a dissected view of a search result within the categories themselves.

The use of the dynamic directory 235 may be particularly helpful if specific information is sought within a search query or to discover certain categories that are implicit with a search result. A user may narrow the results from a search result by clicking on a particular category and view the search results that are associated with the category. The information displayed in a category may be displayed in structured sub-directories to allow the user to further narrow the result. For example, electronic communications within a search result that have attachments may be viewed in the attachments category 240. By expanding this category 240, the electronic communications having attachments and the types of attachments may be viewed 241. In this example, X % of the electronic communications in the search result have MS Word attachments, Y % of the electronic communications in the search result have image attachments, and Z % of the electronic communications have ASCII text attachments.

In yet another example, electronic communications in a search result are filtered into a money category 245 with communications that discuss money amounts. The communications are then placed in sub-categories 246 according to the amount of money related to each electronic communication. As shown in FIG. 2B, there are three money amount subcategories: $300, $160 Million, and $2.5 Billion. A user may click on one of these sub-categories to view the communications that were filtered into the sub-category.

One skilled in the art will recognize that the dynamic directory 235 may contain various types of categories. FIG. 2B shows exemplary categories: Year 236, Quarter 237, Mailing Lists 238, Companies 239, Attachment Types 240, URLs 242, Phone Numbers 243, Email Addresses 244, and Money 245. Other embodiments of the invention may include other categories in the dynamic directory 235.

3. Related Concepts Tab

FIG. 2C illustrates a related concepts tab 250 according to one embodiment of the invention. This tab may suggest other search queries related to a particular investigation or query of electronic communications. In one embodiment, a search query is analyzed relative to a particular investigation of electronic communications and other search queries are suggested. These related concepts may help a user refine a search or suggest queries for a search. The related concepts may also provide a thumbnail sketch of search results including an overview of topics discussed within any plurality of the messages of the search results.

FIG. 2C shows an exemplary list of related concepts in which four related concepts, Related Concepts A-D, 255-258 are shown. A user may click on one of these related concepts and either generate a new search query or refine results from a previous query.

4. History

FIG. 2D illustrates a history tab 270 according to one embodiment of the invention. The history tab 270 may contain a log of each query a user submits to the search engine. This log may include a date column 272 that communicates the day in which a search was performed and a time column 274 that identifies a time during which the search occurred. The log may also contain a query column 276 that identifies the search terms or phrases used for a search query. A user may click on one of these dates, times or queries and retrieve a corresponding search result.

C. Results Pane

According to one embodiment of the invention, the results pane 120 shows the results of a search query in a hit list format in order of relevance or other user-specified sort criteria (e.g., electronic communication date). As mentioned above, the present invention provides a number of different types of search criteria that may be used to generate a search result. The search result may then be analyzed by tools that allow a user to refine a search, view the search result in various formats, integrate data from a secondary source with the search result, and focus on a specific type of data associated with an electronic communication(s) in the search result.

The results pane 120 also allows a user to toggle between different displays or views of a search result. For example, if a user wanted to focus on a thread analysis of electronic communication(s) in a search result, the user can quickly display a screen that provides this analysis and displays its results. Also, if a user wanted to focus on a particular person(s) who is the subject of or participant in electronic communication(s), the user can quickly display corresponding screens for analysis of the person(s).

1. Messages Tab Display

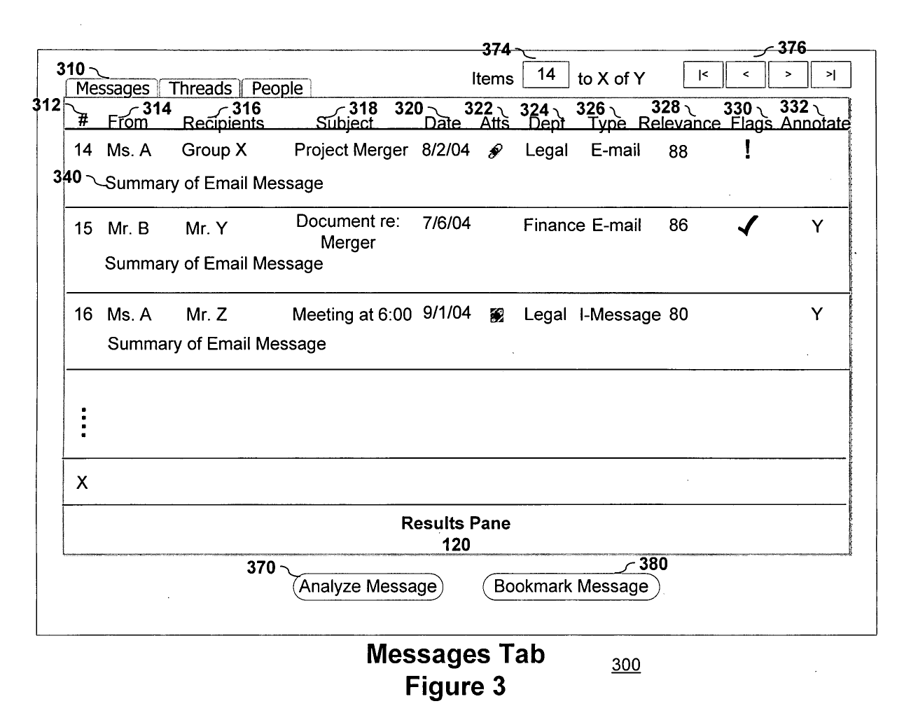

FIG. 3 illustrates a message tab display 300 according to one embodiment of the invention. This display 300 may be used as a default display to show a search result hit list after a search on electronic communications is performed. This particular display 300 contains a plurality of columns that show data associated with electronic communications that were identified during a search as well as control icons that allow a user to change/modify the display view. It is important to note that the message tab display 300 may contain information, associated with a particular electronic communication, which was derived from a secondary source (i.e., a source other than the electronic communication itself). For example, as will be discussed below, this display 300 may contain information from a company directory about a participant in the electronic communication.

The message tab display 300 includes a number (#) column 312, a sender column 314, a recipients column 316, a subject column 318, a date column 320, an attachments column 322, a department column 324, a communications type column 326, a relevance column 328, a flags column 330, and an annotation column 332. The message tab display 300 also includes display control icons such as an item box 374 that indicates a position of a selected electronic communication in the search result hit list and allows a user to select a particular communication by typing the communication number into the box 374. The display 300 also includes arrow icons 376 that allow a user to quickly navigate a search result hit list. These arrow icons 376 may include a forward button, a back button, a start button that returns a user to a first page of a result, or an end button that takes a user to the last page of a result.

After a search is performed, each electronic communication in the hit list is assigned a number. This number may be displayed in the number column 312. If the hit list is ordered according to relevance, then the lower number electronic messages would have been assigned a higher relevancy to the search query.

The sender of each electronic communications may be displayed in a sender or from column 314 and a recipient(s) of each of the electronic communications may be displayed in a recipients column 316. Additionally, the subject of each of the electronic communications may be displayed when possible in a subject column 318. According to one embodiment of the invention, the subject is taken from a subject heading associated with the electronic communication. Furthermore, the date of each of the electronic communications may be displayed in the date column 320.

The display 300 may also show whether each of the electronic communications has an attachment by indication in the attachment column 322. This indication may be provided by the use of an icon, such as a standard attachment paperclip icon, or through a letter such as “Y” for yes. Furthermore, the attachment column may further indicate whether a particular attachment contains a key word match or hit associated with the search. In one embodiment, a green paperclip indicates that such a match occurred in the particular attachment. The display 300 may also identify the specific type of electronic communication, included in the hit list, such as an email message, an instant message, an SMS message, voice message, or video message. This message type is included in the type column 326 of the display.

The display 300 may also show a relevance value for each of the electronic communications in a relevance column 328. This relevance value is generated by the search engine and quantifies the relevance of a particular electronic communication to a search query. A summary 340 of the electronic message may be provided to allow a user to quickly scan the hit list. This summary 340 may be generated by displaying portions of the message that contain terms within the search query or the electronic message may be otherwise parsed to give a user a quick snapshot of its contents.

Other data may be displayed in the message tab view 300 that was not derived from an electronic communication but may be particularly useful to a user. For example, a flag column 330 may show whether any flags were manually set by a user or investigator to highlight a particular electronic communication. To provide further information, a user may annotate a message corresponding to a particular electronic communication in the hit list. The annotate column 332 may indicate whether such an annotation exists and a user may click on the message to view the annotation.

Data from other secondary sources, such as a company user directory, a competitor directory, or customer directory, may be displayed to further supplement the information displayed in the message tab view 300. One such type of secondary source data is a department associated with the sender or recipient of a particular electronic message. This department data may be retrieved from an internal company directory that lists information, including a department in which a person works, associated with a participant of an electronic communication. In addition, an analysis of companies associated with a domain name may be performed using an external company directory source to identify a specific company associated with a domain. Furthermore, relevant events may also be obtained from calendaring systems and the like. This secondary source data may be displayed in corresponding columns within the message tab view 300. For example, a department associated with a sender of each of the electronic communications may be displayed in the department column 324.

The message tab view 300 may also include various functional buttons or icons that allow a user to perform certain operations on one or more of the electronic communications in a search query hit list. For example, an analyze message button or icon 370 allows a user to perform various analysis operations on a message or search result list. These operations, and corresponding displays, will be described in detail below. Additionally, a bookmark button or icon 380 allows a user to save a bookmark to a selected message(s) or entire hit list. According to one embodiment of the invention, a user may save the bookmark(s) in a folder that is displayed in the navigation window described above.

2. Message View Display

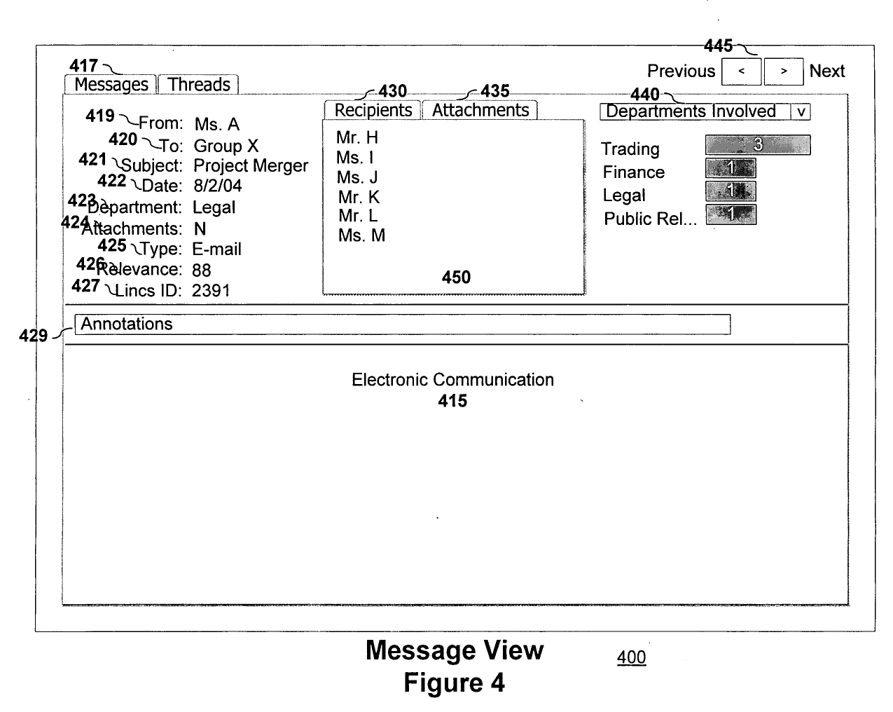

FIG. 4 illustrates a message view display 400 according to one embodiment of the invention. The message view display 400 is a detailed display showing information about a single electronic communication and/or its relation within a search query hit list.

The message view display 400 may include a tab(s) 417 that allows a user to toggle between various screens. The message view 400 may also include control buttons 445 that allow a user to click through both previous and next messages within a search result list.

The message view 400 displays various data relating to a particular electronic communication, which may include the communication sender 419, the communication recipient 420, a subject associated with the communication 421, a date 422, a department 423, attachments 424, a communication type 425, a relevance of the communication 426, and an identification number 427. The specifics of each of these data types is described above in relation to the message tab view 300 and is intended only to be exemplary data types that may be used to describe an electronic communication. One skilled in the art will recognize that other types of data may be used to provide a user information about a particular electronic communication.

The message view 400 may also include an interactive display of recipients 430, attachments 435, or other relevant types of data associated with an electronic communication. This interactive display allows a user to further breakdown information about an electronic communication. For example, the recipients tab 430 provides a user a complete list of all recipients of an electronic message. In yet another example, the attachments tab 435 provides a user a complete list of all attachments associated with an electronic message. This interactive display is another example of the invention's ability to display information, related to a search query hit list or a particular electronic communication therein, on various levels of detail. These varying detail levels of the displays provide a user a platform in which large number of electronic communications may be effectively filtered and efficiently analyzed.

The message view 400 may also include a drop down menu(s) 440 that allows a user to toggle between different types of analysis charts. In one embodiment, a drop down menu allows a user to select charts that identify information about a particular electronic communication being displayed in the message view 400. For example, the drop down menu 440 may display a chart showing the departments represented by recipients of the particular communication, and the number of recipients from a department that received the particular communication. The drop down menu 440 may address a large number of different kinds of analytical functions including companies to which or from whom communications were sent, or an analysis of domain addresses may be provided. In general, the drop down menu 440 may include any information about the communication including information describing how the communication relates to one or more threads. One skilled in the art will recognize that numerous different types of data may be included and analyzed in the drop down menu 440.

The message view 400 may also include a display of the electronic communication itself including both the message header (if there is one) and the body of the message 415. Furthermore, this display of the particular electronic communication 415 may just display the body of the message and a summary of header information. The message view 400 may also provide an annotation box 429 in which a user may provide text to comment on the particular message. Furthermore, there may be a bookmark function on the display to allow the user to save a bookmark to the message and any corresponding annotations. This bookmark function may save this information in the directory architecture described above.

3. Threads Tab Display

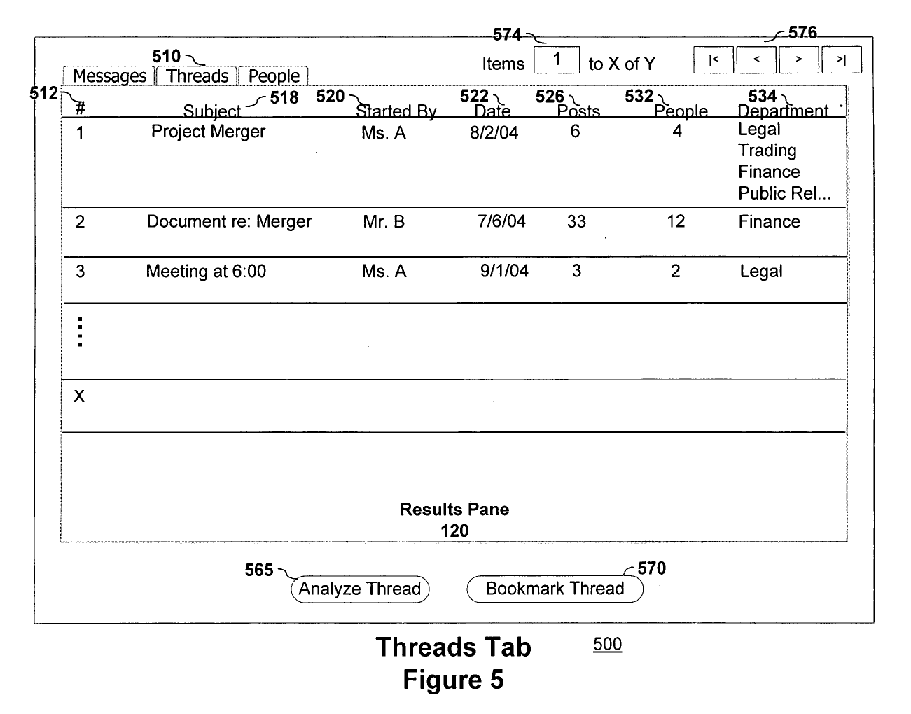

FIG. 5 illustrates a threads tab display 500 according to one embodiment of the invention. This thread tab display 500 may be viewed within the results pane 120 by clicking on the threads tab 510. This display 500 shows a series of electronic communications, referred to as a thread, which relate to each other. Oftentimes a thread is generated by a series of reply messages between electronic communication participants. A thread is typically viewed in chronological order so that a user may see how the communication between the participants developed over time. However, a thread may be displayed in various different formats to highlight a certain aspect(s) of the communication within the thread.

The threads tab display 500 may include various control features such as an item number 574 that allows a user to manually select a particular thread according to its number or by using previous, next, end and begin buttons 576 that also a user to scroll through threads that were generated in a search query hit list.

The display 500 may contain multiple columns to show different attributes of the threads that were generated from a search query. These columns may include a thread number column 512, a subject column 518, a started by column 520, a date column 522, a posts column 526, a people column 532, and a department column 534. The number column 512 includes a number that is assigned to each thread that is selected by a search query. Typically, the threads are displayed in sequential number in the display 500 according to their relevancy to the search query.

The subject matter of each thread is described in the subject column 518. The subject of a thread may be retrieved from the subject heading of one or multiple electronic communications within the particular thread. The person who initiated the thread, typically by sending out the first electronic communication, and the date the thread was started are displayed in the “started by” column 520 and the date column 526.

The number of communications or messages is shown in the posts column 526 which allows a user to quickly identify the length of a thread. The number of participants in the thread is shown in the people column 532. The display 500 may also include a list of departments, associated with participants in the thread, in a department column 534. As described above, this information associating departments with thread participants may be retrieved from a number of different secondary sources. The display 500 may also include other columns relevant to information contained within the thread, the electronic communication in the thread, or from secondary sources that may be associated with the thread or communications therein.

The display 500 may include an “analyze thread” button 565 that may initiate various analysis operations on the thread; exemplars of these operations and their displays are described in detail below. The display 500 may also include a bookmark button or icon 570 to allow the user to save the thread and any corresponding annotations. This save function may save this information in the directory architecture described above.

4. Thread View Display

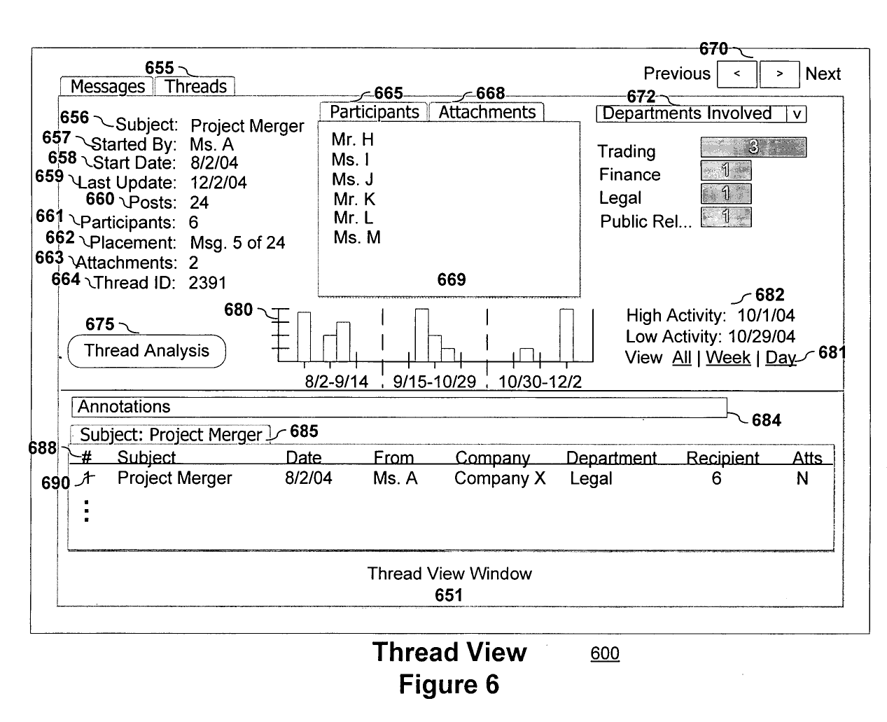

FIG. 6 illustrates a thread view display 600 according to one embodiment of the invention. This thread view display may be opened by clicking on the above-described “analyze thread” button 565 in the thread tab display 500.

The thread view display 600 may contain various descriptions of a particular thread including a thread subject 656, who started the thread 657, when the thread was started 658, when the thread was last updated 659, the number of messages or posts in the thread 660, the number of participants in the thread 661, the placement or rank 662 of the selected thread in the thread tab display 500, the number of attachments in the thread 663, and the thread identification number 664. This list is not intended to be exhaustive and the thread view display 600 may contain any number of combinations of this information. The thread view display 600 may also contain other information descriptive of the thread that was obtained directly from the thread or from a secondary source.

The thread view display 600 may also include an interactive display of thread participants 665, attachments within the thread 668, or other relevant types of data associated with the thread. This interactive display allows a user to further breakdown information about the thread and quickly analyze the information. The participants tab 665 provides a user a complete list of all participants, and a corresponding level of activity, in the thread. In yet another example, the attachments tab 668 provides a user a complete list of all attachments contained within the thread. There may be other information types within the interactive display that allow a user to see information associated with the thread at a more detailed level.

The thread view display 600 may also include a drop down menu(s) 672 that allows a user to toggle between different types of analysis charts. In one embodiment, a drop down menu allows a user to select charts that identify information about electronic communications within a particular thread. For example, the drop down menu 440 may display a chart analyzing the departments and respective message quantities within the thread itself. This feature allows a user to quickly identify threads relevant to a particular department or work group in a company. The drop down menu 440 may address a large number of different kinds of analytical functions including companies associated with electronic communications within the thread, departments associated with electronic communications within the thread, or an analysis of domain addresses of electronic communications within the thread may be provided. The drop down menu 440 may also be used to correlate information about attributes that have already been obtained such as date ranges, concepts, etc. One skilled in the art will recognize that numerous different types of data may be included and analyzed in the drop down menu 440.

The thread view display 600 may also include various charts to provide a user a particular view of a thread. For example, an activity chart 680 may be included that shows a timeline of thread postings. This timelines gives a user a chronological look at the volume of electronic communications related to particular time periods. This feature may help a user pinpoint particularly important time periods in which further analysis of a thread is warranted. A user may change the time periods displayed in the chart by zooming in and out using a function such as the “All|Week|Day” operation that changes the parameters of the chart.

Other features and information related to these charts may also be provided. For example, a time period that has the highest amount of activity may be provided 682 or a time period that has the lowest amount of activity may also be provided. The chart may also include highlights, such as changing colors, that identify important or user selected time periods relative to the thread. These other features may be provided in the thread view display 600 or provided in other windows by selecting a thread analysis 675.

The thread view display 600 may also include an annotation block 684 that allows a user to provide descriptions or notes related to the thread. The user may also use flags to identify certain threads. For example, the flags may be color coded to communicate certain significance of the thread relative to an investigation. These flags and annotations may be saved to better organize an investigation and later read by the user or another individual.

A list of electronic communications within a thread, typically having the same or similar subject matter (identified in tab 685) are displayed in the thread view display 600. General information about each of the communications may be provided in various columns 688. An exemplary group of columns is shown including a message number column, which ranks the message according to relevance to a particular subject, a subject column, a date column, a sender or from column, a company column, a department column, a recipient column, an attachments column. Each of these columns provides a user a snapshot of each of the electronic communications within the thread. The group of messages shown to be members in the thread may be sorted on any of the available columns.

a) Thread Analysis Charts

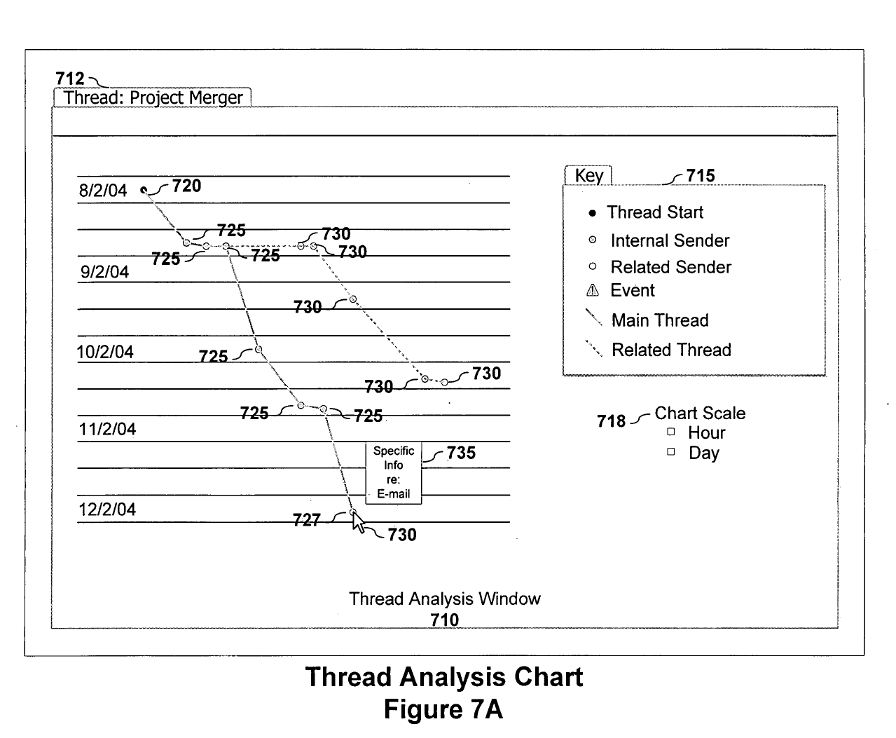

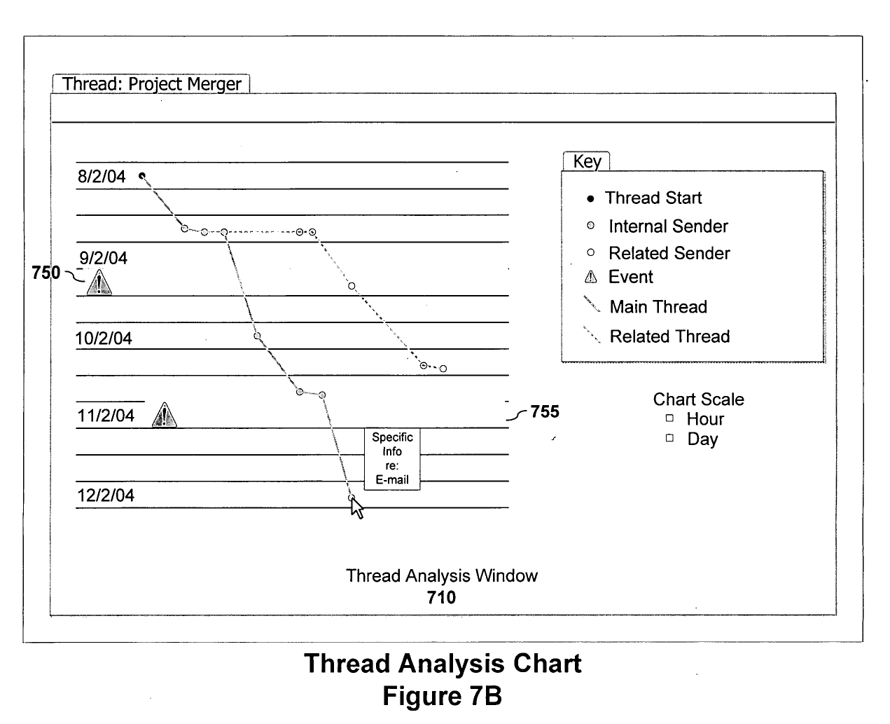

FIG. 7A illustrates a thread analysis chart according to one embodiment of the invention. The thread analysis chart may be contained within a thread analysis window 710 with a tab 712 that identifies the subject matter of the analyzed thread. In another embodiment, the thread analysis chart does not appear in a separate window but is generated within a frame, a tab or other area of a window.

In one embodiment of the invention, the thread analysis chart contains a line diagram that illustrates the thread communications relative to time. An initial electronic communication 720 is identified on the chart that initiated the thread. Subsequent electronic communications are plotted on the diagram and line is used to connect the plotted communications. In the diagram, subsequent communications 725 are identified with a particular icon or dot to clearly illustrate the messages within the primary thread.

Related threads that break-off from the primary thread may also be plotted in the thread analysis chart. According to one embodiment, electronic communications 730 within a related thread are identified with a different icon or dot than those in the primary thread. This plot illustrates not only the primary thread but also any related threads, including the point in which each related thread breaks off from the primary and the time at which the break-off occurred. The line used to connect the primary thread and any related threads may be different, such as dashed, to visually highlight the fact that the two threads are different.

A user may view information particular to an electronic communication within a primary or related thread by scrolling a pointer 730 across an icon or dot corresponding to the particular communication. According to one embodiment, a pop-up window 735 containing summary information about the particular communication appears when the pointer moves over the icon representing that communication 730. As illustrated, the pointer passes over dot 727 and the pop-up window 735 appears providing summary information about the electronic communication related to dot 727. In another embodiment of the invention, a user may click on a particular dot or icon and the message view window 400 is generated that provides information about the particular electronic communication and provides for further analysis based on this particular communication.

The thread analysis window 710 may also contain a key 715 that identifies the various different icons, symbols, dots and lines that are used in the thread analysis chart. The chart may also be scaled by using a chart scale 718 operation. In one embodiment, the chart scale 718 allows the chart to be scaled to an hours chart or a day chart. This scaling allows a user to adapt the visual display of a thread analysis chart according to its length and the volume of electronic communications therein.

Each thread analysis chart may be bookmarked for later reference. A user may also attach an annotation to the chart as a reminder or to provide input to a colleague that will later view the chart.

FIG. 7B illustrates a thread analysis chart according to one embodiment of the invention. In this figure, events are overlaid on the chart to allow a user to visualize the thread progression relative to certain important events. This feature may be an effective tool when threads are being analyzed during an investigation. For example, a particularly important meeting date 750 is overlaid on the thread line chart. In yet another example, a stock drop date 755 is highlighted on the thread line chart. This feature allows a user to identify electronic communications that took place relatively close to the important events.

One skilled in the art will realize that numerous features may be included in the thread analysis chart to better visualize a thread progression relative to time, specific occurrences, subject matter, or other threads. For example, analysis and visualization may be provided for data related to changing participants, escalation or private conversations, relations to other contemporaneous threads or messages, topical changes within the content of a message, etc.

5. People Tab Display

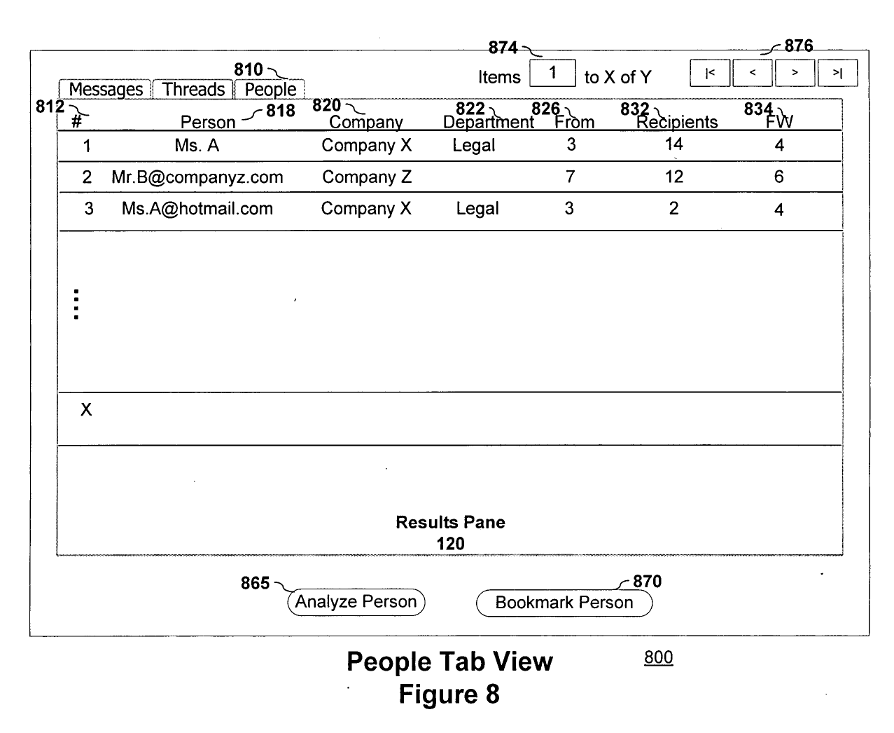

FIG. 8 illustrates a people tab display 800 according to one embodiment of the invention. The people tab display 800 provides a user information about people who have participated, or been discussed, in electronic communications or threads identified from a search query. This display 800 allows a user to either identify individuals that may be relevant to a particular search or to further refine a search by focusing on a particular participant(s) or individual that is discussed.

The people tab display 800 may be shown in the results pane 120 by toggling to a people tab 810 after a search is performed. The people tab display 800 may include various control features such as an item number 874 that allows a user to manually select a particular individual according to a number or to use previous, next, end and begin buttons 876 that also a user to scroll through people that were identified in a search query hit list.

The display 800 may contain multiple columns in which information about people that were identified as relevant to a search query. These columns may include descriptive data such as a person number column 812, a person column 818, a company column 820, a department column 822, a from column 826, a recipients column 832, a forward column 834, and a unique id column. The number column 812 includes a number that is assigned to each individual that is identified as relevant to a search query. The person column 818 provides the name of the person and/or email address of the person.

A company corresponding to each person is displayed if known in the company column 820. The company may be identified from an electronic communication, such as from a domain address on an email, or from a secondary source such as an internal company directory or competitor list. The people view display 800 may also list a department, if known, in which each person works in the department column 822. This department information is retrieved from a secondary source and associated with the person or email address.

The display 800 may identify the number of electronic communications, identified by a search, which the person or electronic communication address sent. This information may be provided in the from column 826. In addition, the display 800 may show the number of electronic communications, identified by the search, which the person or electronic communication address received. A recipients column 832 shows this information to a user.

The display 800 may also identify other actions by an individual relative to the electronic communications identified by a search. For example, a forward column 834 may identify the number of times a person forwarded an electronic communication in the search query. The display 800 may include any information known about a person and how that person relates to the search result, such as the number of messages in which the person was mentioned, the person's tenure with a company, a link to company records concerning the person, and the person's status or role relative to the investigation.

The display 800 may include an “analyze person” button 865 that may initiate various analysis operations on the person; exemplars of these operations and their displays are described in detail below. The display 800 may also include a bookmark button or icon 870 to allow the user to save a reference to the person and any corresponding annotations. This bookmark function may save this information in the directory architecture described above.

a) Person View Display

The person view 900 is a detailed display showing information about a single individual or electronic communication address and/or its relation within a search query hit list. The person view 900 may include a tab(s) 917 that allows a user to toggle between various screens. The person view 900 may also include control buttons that allow a user to click through both previous and next persons relevant to the search query.

The person view 900 displays various data relating to a particular individual, which may include a name 919, a company 920, a department 921, an email address 922, a number of mailing lists 923, attachments 924, a communication type 925, a relevance of the communication 926, and an identification number 927. This information provides a user information that may be relevant to an investigation and/or analysis. One skilled in the art will recognize that other types of data may be provided that describe a particular individual.

The person view 900 may also include an interactive display of email addresses 930, mailing lists 935, also known as (“AKAs”) 937, attachments 940 or other relevant types of data that may be associated with an individual. This interactive display allows a user to further breakdown information about the person. For example, the email addresses tab 930 provides a user a list of alternative email addresses used by this person. In another example, the mailing lists tab 935 provides a user a complete list of the mailing lists that contain an email address associated with the individual. This list of mailing lists may be generated by comparing the individual's email addresses to addresses within the mailing lists identified within the company directory, messaging system or other source. In yet a further example, the AKAs tab 937 may display another list of email addresses that may be associated with the individual. These email addresses may be identified by a name that is embedded within an email or generated by recognizing permutations of an individual's name and associating those permutations with a known domain email service provider. For example, a firstname.lastname@hotmail.com email address would be associated with the individual having the first and last name in the email address. In a final example, an attachments tab 940 may display a list of attachments to electronic communications associated with the particular individual. This interactive display allows a user to obtain more detailed information about a particular individual within the same window. Furthermore, this information may be obtained from a number of different sources including the electronic communications themselves or from a secondary source.

The person view 900 may also include a list of the electronic communication addresses that are associated with a particular individual as well as data regarding each of these addresses. Exemplar columns 960 containing particular types of data describing the communications are provided including an email address number column, email address column (either “to” or “from” depending on whether the address sent or received the communication), a company column, a department column, a message count column, a number of attachments column, a flags column. This list of communication addresses may be divided according to whether the address received or sent communications. According to one embodiment, a “Received” tab 955 is used to show addresses that the particular individual received communications from and a “Sent” tab 957 that shows addresses that the particular individual sent communications to.

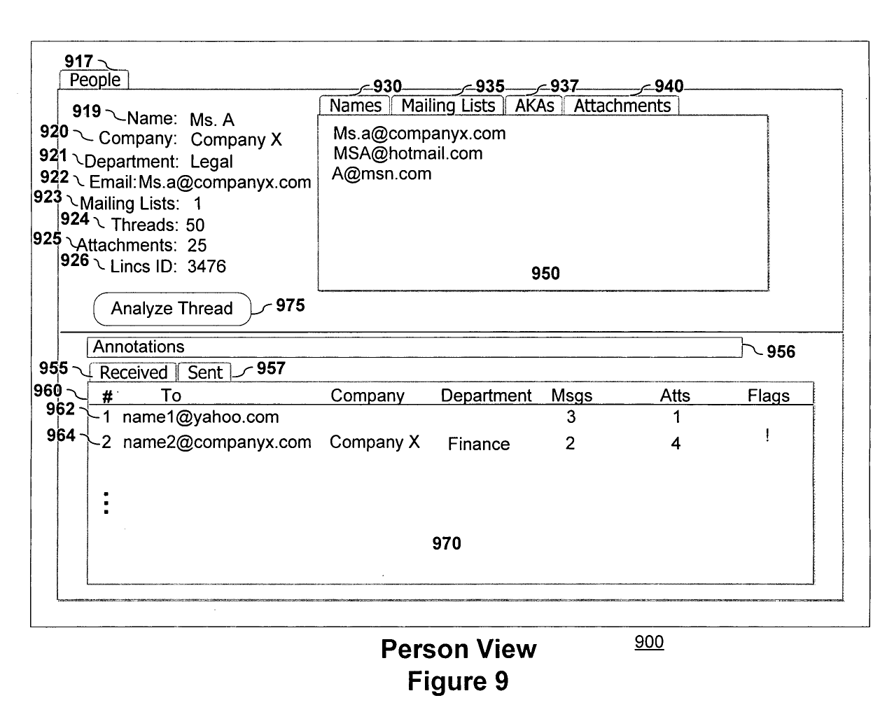

For exemplary purposes, two such listings are provided in FIG. 9. A first listing 962 identifies an email address with a name permutation (“name1”) that was associated with the individual. In short, this is a yahoo email account for the individual that was identified through matching name permutations of the individual with emails generated by the search query. Other data relating to this email address is provided in the other columns. A second listing 964 identifies a company X email address for the individual. This email address may have been identified because the individuals name was embedded within the email, the address may have matched a name permutation, or the address was retrieved from a secondary source such as company X's email directory. Once again, other data relating to this email address is provided in the other columns.

The person view 900 may also provide a method in which a user may provide an annotation 956 to comment on the particular individual. Furthermore, there may be a bookmark function on the display 900 to allow the user to save a reference to the information about the individual and any corresponding annotations. This bookmark function may save this information in the directory architecture described above.

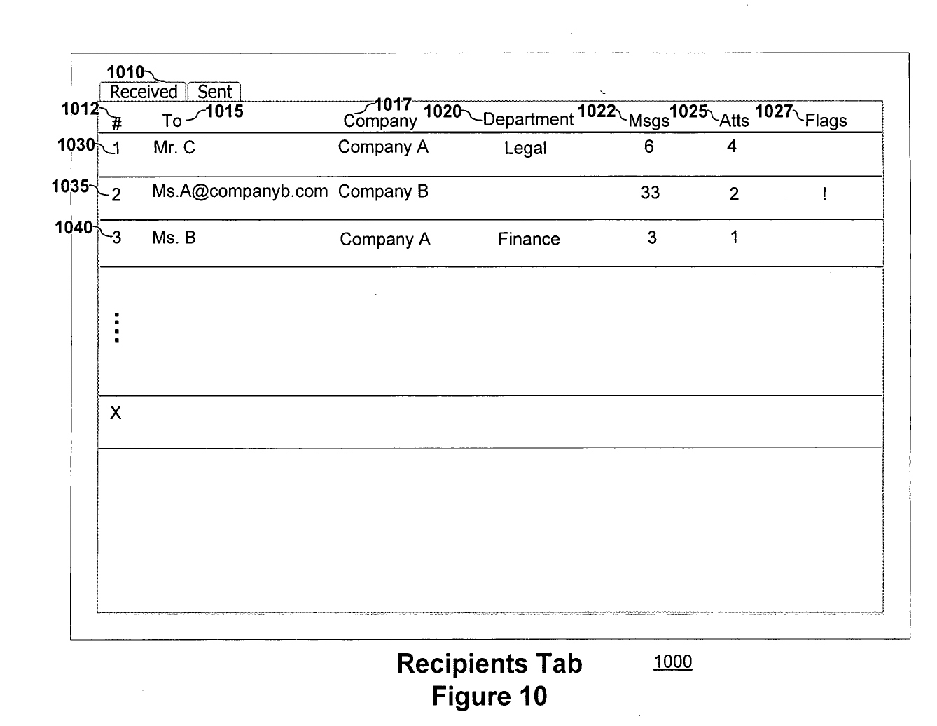

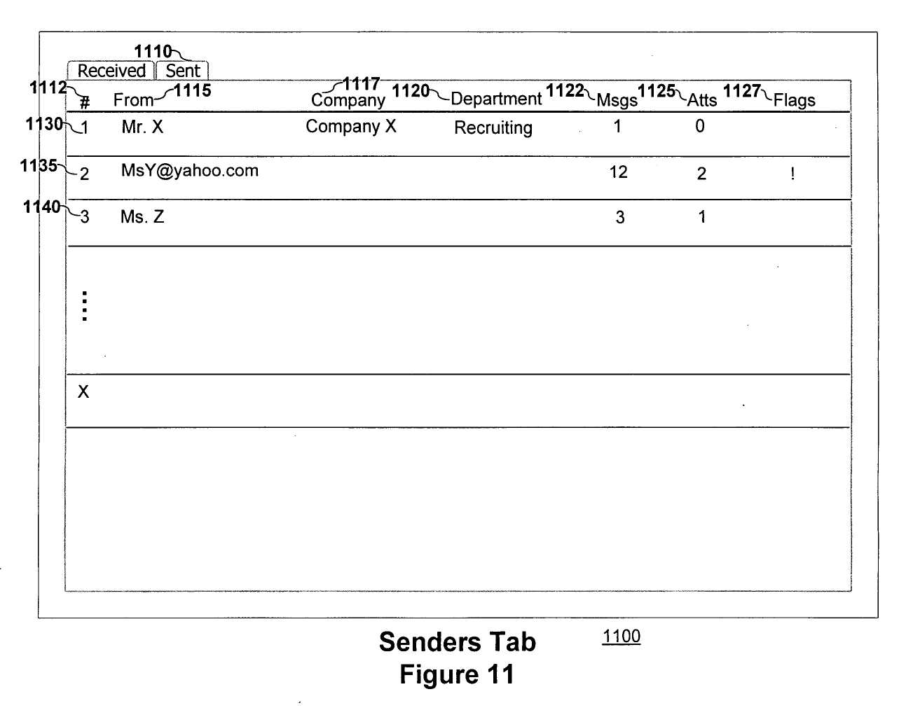

The particular individual may be further analyzed by identifying people with whom the individual has communicated. For purposes of describing FIGS. 10 and 11, this particular individual that is being analyzed will be identified as “the particular individual” and people to whom the individual has sent communications will be identified as “recipients” and people from whom the individual has received communications will be identified as “senders.”

b) “Sent” Tab Display

FIG. 10 illustrates a “Sent” tab display 1000 according to one embodiment of the invention. This display 1000 provides a user a list of identified recipients, and data associated therewith, with whom the particular individual has sent communications. This display includes a number of columns that describe these recipients including a recipient number column 1012, a to column 1015, a company column 1017, a department column 1020, a messages column 1022, an attachments column 1025, a flags column 1027.

The name column 1015 may display the recipient's name or email address. The recipient's company and department are shown in the corresponding columns 1017 and 1020. This company and department information may be retrieved from an electronic communication directly or from a secondary source. The messages column 1022 shows the number of electronic communications that were received from the particular recipient and the attachments column 1025 shows the number of attachments in these electronic communications. A flags column 1027 allows a user to flag certain recipients for later use or for another user.

This “Sent” tab display 1000 allows a user to specifically track electronic communications that were sent by a particular individual and analyze those communications. This feature is particularly valuable for any kind of investigatory work that is being done on a large number of electronic communications.

c) “Received” Tab Display

FIG. 11 illustrates a “Received” tab display 1100 according to one embodiment of the invention. This display 1100 provides a user a list of identified senders, and data associated therewith, from whom the particular individual has received communications. This display includes a number of columns which describe these senders including a sender number column 1112, a from column 1115, a company column 1117, a department column 1120, a messages column 1122, an attachments column 1125, a flags column 1127, and a unique ID column.

The name column 1115 may display the sender's name or email address. The sender's company and department are shown in the corresponding columns 1117 and 1120. As was the case with recipient communication, this company and department information may be retrieved from an electronic communication directly or from a secondary source. The messages column 1122 shows the number of electronic communications that were sent from the particular sender and the attachments column 1125 shows the number of attachments in these electronic communications. A flags column 1127 allows a user to flag certain recipients for later use or for another user.

d) People Analysis Chart

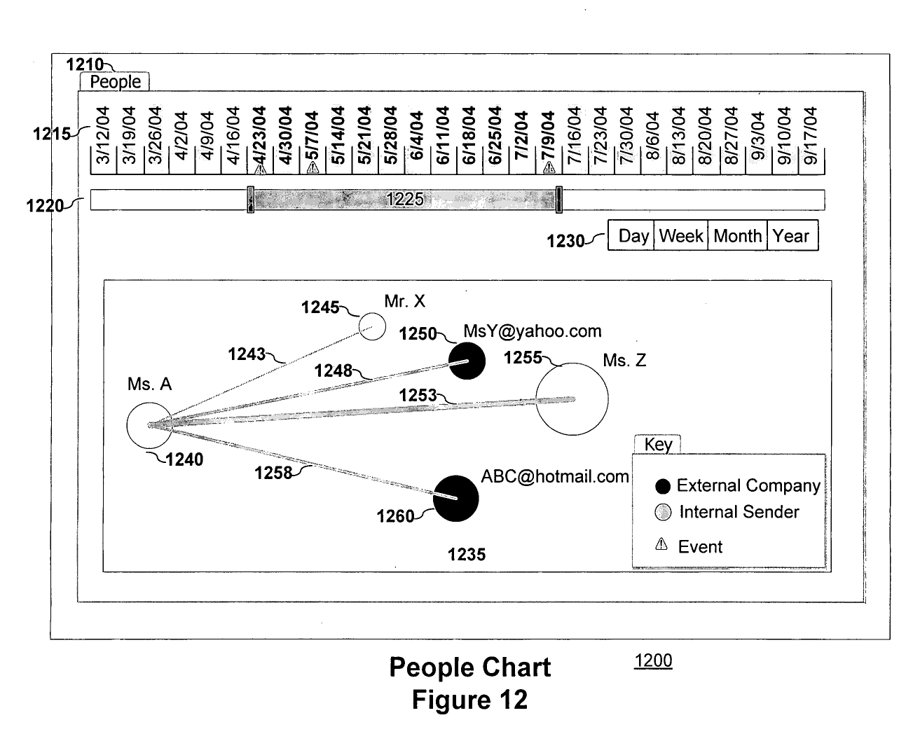

FIG. 12 illustrates a people analysis chart 1200 according to one embodiment of the invention. This chart 1200 provides a user an effective visualization of an individual's electronic communications history and habits. This chart 1200 graphically illustrates particular aspects related to electronic communications in a single platform that allows a user to see a broad picture of electronic communication history associated with a particular individual. The use of colors, patterns, sizes, intensities and other visual characteristics are employed to achieve this visualization.

The people analysis chart 1200 includes a graphical window 1235 in which graphics related to a particular individual's electronic communication history and habits may be displayed. In this particular embodiment, a chart is shown comprising multiple circles that relate to participants in the relevant electronic communications. A first circle 1240 represents the particular individual, Ms. A, and the remaining circles represent a list of people with whom she communicated electronically. This list includes Mr. X 1245, MsY@yahoo.com 1250, Ms. Z 1255, and ABC@hotmail.com 1260. The size of these circles varies relative to the amount of communications with Ms. A. Thus, a large circle such as the one representing Ms. Z 1255 indicates that a large volume of communication occurred. Comparatively, a smaller circle such as the one representing Mr. X 1245 suggests that a relatively smaller amount of communication occurred.

The people in the chart 1200 may be identified according to their names, such as Ms. A, Mr. X, or Ms. Z, or by an electronic communication address, such as the email addresses MsY@yahoo.com and ABC@hotmail.com. The names associated with the addresses may be identified directly from the communication itself or from a secondary source.

Other graphical representations may also be provided to visualize aspects of a particular individual's electronic communication history. For example, the line connecting Ms. A 1240 to the various people with whom she communicated may vary in thickness relative to the volume of communication. According to this particular illustration, the thickest line 1253 between Ms. A 1240 and Ms. Z 1255 indicates that a relatively large amount of communication occurred. Comparatively, a thin line 1243 would suggest that a smaller amount of communication occurred. This variation in line thickness is just another example in which attributes of a particular individual's electronic history may be visualized to a user.

The people chart 1200 may also include various control features that enable a user to define what information is displayed in the people chart. According to one embodiment, a time line 1215 is included to define a time period in which electronic communications are analyzed and displayed. This time line 1215 may be scaled and partitioned into various segments including hours, days, months and years. A user may select a scaling factor from a control feature 1230 that defines the level of detail for a particular chart.

According to yet another embodiment of the invention, a user may dynamically change the date range of the chart by a sliding tool 1220 that further defines a date range. As illustrated, a highlighted section on the sliding tool 1225 sets the date range of the particular people chart 1200. Accordingly, a user may focus an analysis between two particular dates to see an individual's electronic communication between these dates.

A number of different visual tools may be integrated within the people chart 1200 to provide an effective investigatory display for a user. In addition, these visual tools are able to supplement the integration of data from multiple sources, such as both electronic communications and secondary sources, which present a user with a big picture view of an individual's electronic communication history and habits. For example, details about a person and/or messages passed between two people may be displayed when a user mouse over a corresponding circle or line. Furthermore, drill-down features are supported so that when a user clicks on a line or circle, a corresponding view of a collection of messages or other people associated with a person is shown. One skilled in the art will recognize that these facilities may be used to display many other kinds of information about people and their relationships to other entities (e.g., events, concepts, etc.).

6. Concepts Tab View

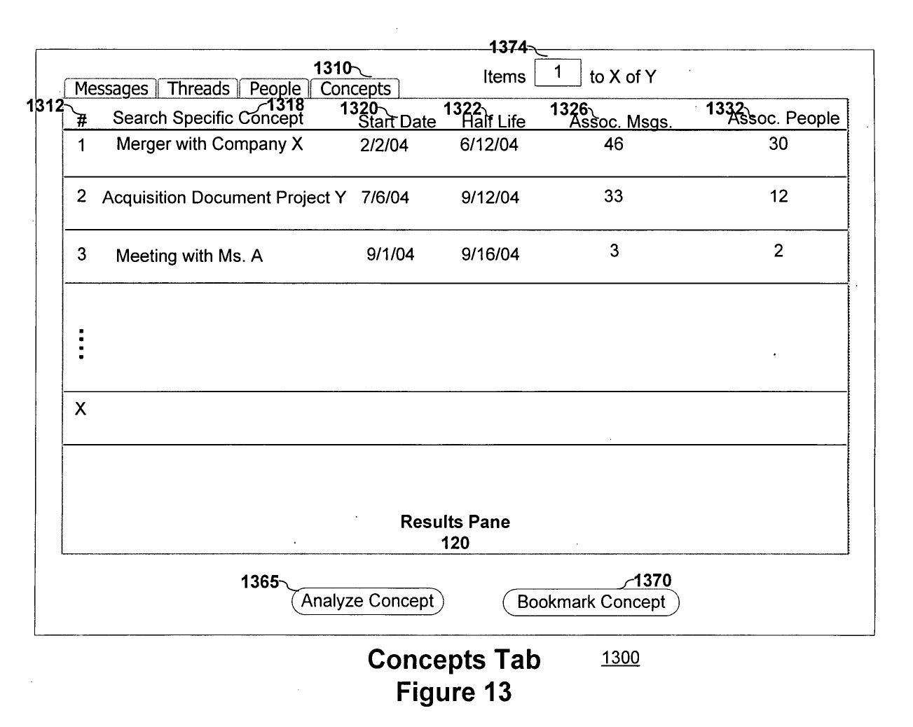

FIG. 13 illustrates a concept tab display 1300 according to one embodiment of the invention. This particular display 1300 contains a plurality of columns that contain data associated with the content within electronic communications that were identified during a search as well as control icons that allow a user to change/modify the display view.

The concept tab display 1300 includes a number (#) column 1312, a search specific concept column 1318, a start date column 1320, a half life column 1322, an associated messages column 1326, an associated people column 1332. A concepts tab 1310 allows a user to toggle between various displays within the results pane 120.

The number column 1312 shows a number associated with each concept in the concept list. The search-specific-concept column 1318 provides a list of terms, phrases, or other representations of concepts that were identified as important within the electronic communications that comprise the search result. A start date column 1320 identifies the date when an electronic communication in the search result first used the concept. A half-life column 1322 identifies the half-life of a concept, which is the period of time from which the concept was first used until half of all uses had occurred. This half-life feature is a useful measure of the life of concepts within an organization or group.

The associated messages column 1326 shows the number of electronic communications in the search result that mention the concept. The associated people column 1332 identifies the number of participants who have used the concept in their electronic communications within the search result.

The concepts tab display 1300 also includes display control icons such as an item box 1374 that indicates a position of a selected search concept and allows a user to select a particular concept associated with a number in the box 1374. The display 1300 may also includes arrow icons that allow a user to quickly navigate a list of concepts.

The display 1300 may include an “analyze concept” button 1365 that may initiate various analysis operations on the person; exemplars of these operations and their displays are described in detail below. The display 1300 may also include a bookmark button or icon 1370 to allow the user to save a reference to the concept and any corresponding annotations. This bookmark function may save this information in the directory architecture described above.

a) Concepts Analysis Chart

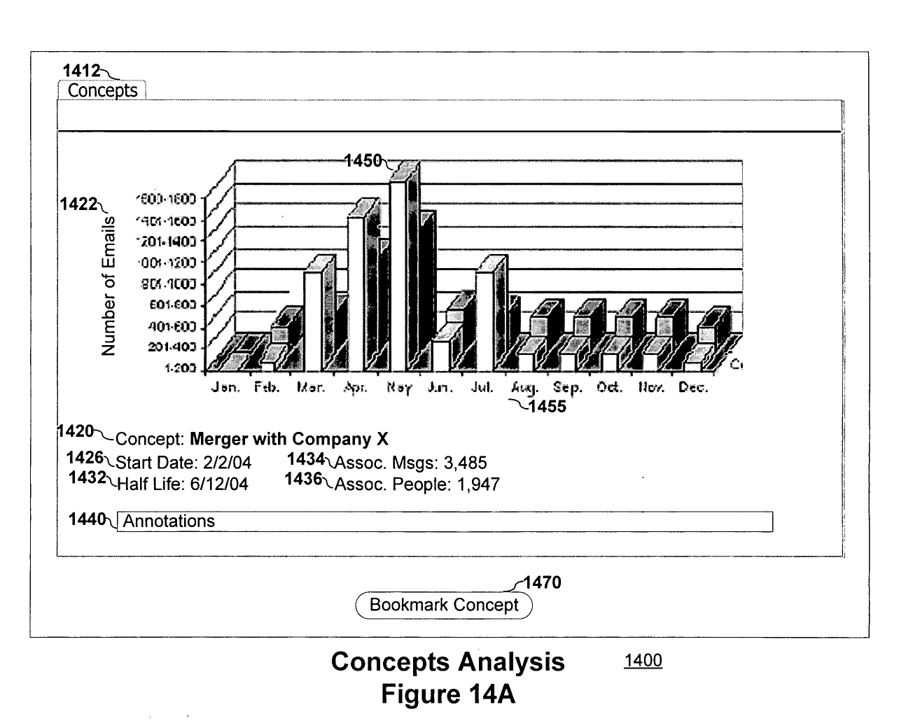

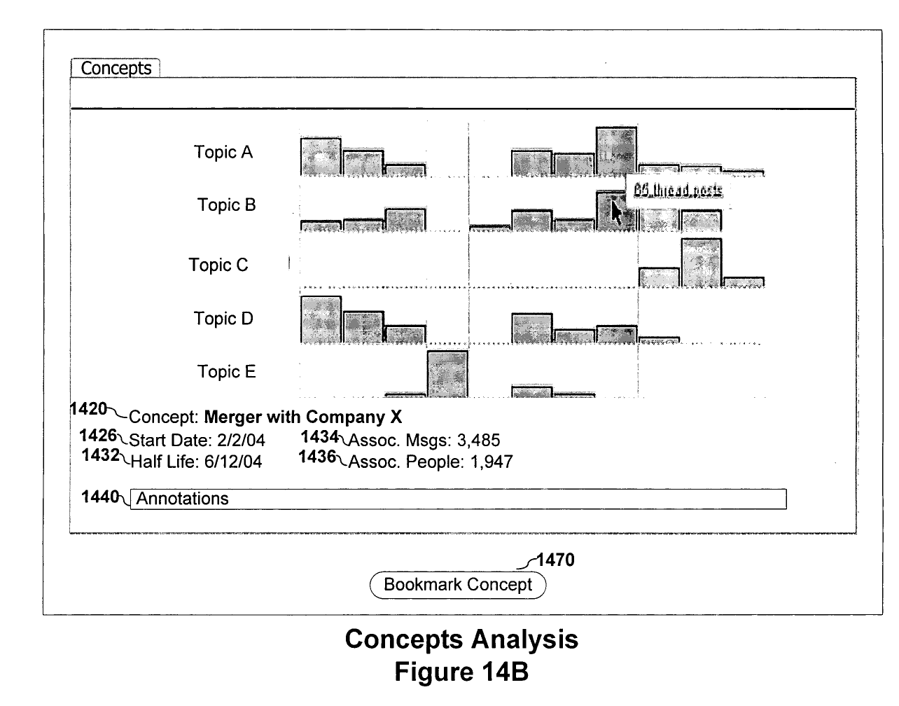

FIG. 14A illustrates a concepts analysis display 1400 according to one embodiment of the invention. This chart 1400 may be generated by clicking on the analyze concept button 1365 described in the concepts tab display 1300. The chart 1400 shows a user in a graphical format particular characteristics related to a concept that occurs within the electronic messages of a search result.

In this particular embodiment, a three dimensional bar chart 1450 is shown to represent the quantity of emails 1422 within a search result that mention the particular concept and how the number of these mentions varies over time 1455. Various information about the particular concept may also be shown in this chart 1400 including the concept itself 1420, the date of first mention of the concept within the search result 1426, the concept's half life 1432, the total number of messages using the concept 1434 identified in the search result, and the number of people 1436 who used the concept within messages in the search result.

The concepts analysis chart 1400 may also include an annotations box 1440 that allows a user to note particular observations about the concept 1400. The chart 1400 may also include a bookmark feature that allows a user to save a reference to the chart, and any annotation associated therewith, for later use. This bookmarking feature may operate within the directory architecture described above.

As with the previous charts, the concepts chart presents a user a big picture view of important characteristics of a potentially large body of relevant electronic communications. In this particular chart, a user is graphically shown the quantity of electronic communications related to a particular concept over time. This chart 1400 identifies volume peaks in certain kinds of electronic communications that would enable a user to more effectively refine an investigation relative to time. The chart 1400 may also include a three dimensional aspect in which electronic communications from particular people is shown. In this particular illustration, two bars are provided for each month, which show the volume electronic communications from two distinct individuals and may include other factors such as the usages of a concept in two different search result lists. This merging of time, concept, electronic communication volume and people provide an investigator a high-level perspective of large amounts of information that enable a more effective refining process in identifying relevant communications.

FIG. 14B illustrates a concepts analysis display according to one embodiment of the invention. This figure shows yet another display that may be used to provide information about various concepts or topics related to an electronic communication(s) or thread.

The same type of information and attributes, illustrated in FIG. 14A, which are related to concepts may be provided to a user including the concept itself 1420, the date of first mention of the concept within the search result 1426, the concept's half life 1432, the total number of messages using the concept 1434 identified in the search result, and the number of people 1436 who used the concept within messages in the search result.

In this particular embodiment, two dimensional graphs are used to provide visualization of information and attributes related to particular topics or concepts. For example, a bar representing the quantity of electronic communications for a particular concept at a point of time or time range is provided to a user. FIG. 14B is yet another example of a graphical illustration in which electronic communication attributes relating to content, concept, time, threads, and people are displayed.

One skilled in the art will recognize that various charts and displays may be provided that merge time, concept, message volume and message participants into a single platform. Furthermore, information obtained from electronic communications or secondary sources, such as company directories, may be merged to present an even broader picture as well as multi-level analysis tools.

While the present invention has been described with reference to certain exemplary embodiments, those skilled in the art will recognize that various modifications may be provided. Accordingly, the scope of the invention is to be limited only by the following claims.

We claim:

1. A user interface relating to an analysis of at least one electronic communication, the user interface comprising:
a first representation of a first electronic communication attribute, associated with the at least one electronic communication, that was derived from the at least one electronic communication; and
a second representation of a second electronic communication attribute, associated with the at least one electronic communication, that was derived from a secondary source.

2. The user interface of claim 1 wherein the at least one electronic communication is selected from a group consisting of an electronic mail, short message service message, instant message, voice message, and video message.

3. The user interface of claim 1 wherein the second communication attribute is derived from a company employee directory.

4. The user interface of claim 1 wherein the first and second electronic communication attributes are contained within the same pane.

5. The user interface of claim 1 wherein the first and second electronic communication attributes are contained in separate panes.

6. The user interface of claim 1 further comprising:
a search pane within the user interface that provides an interface for performing a search query on a plurality of electronic communications; and
a results pane within the user interface that provides an interface for viewing a result of the search query on the plurality of electronic communications.

7. The user interface of claim 6 wherein the results pane provides an interface in which at least one characteristic of the plurality of electronic communications is shown.

8. The user interface of claim 7 wherein the at least one characteristic includes a characteristics selected from a group consisting of messages, threads, people, concepts, and time.

9. The user interface of claim 1 further comprising a navigation pane that provides an architecture in which references to the at least first electronic communication attribute may be stored.

10. The user interface of claim 9 wherein the navigation pane comprises a dynamic directory in which references to the first electronic communication attribute is stored within a sub-directory related specifically to a data type corresponding to the first electronic communication attribute.

11. A computer program product embodied on a computer readable medium for displaying an analysis of at least one electronic communication, the computer program product comprising computer instructions for:
displaying a first electronic communication attribute, associated with the at least one electronic communication, that was derived directly from the at least one electronic communication; and
displaying a second electronic communication attribute, associated with the at least one electronic communication, that was derived from a secondary source.

12. The computer program product of claim 11, wherein the at least one electronic communication is selected from a group consisting of electronic mail, short message service message, instant message, voice message, and video message.

13. The computer program product of claim 11, wherein the second electronic communication attribute is derived from a company employee directory.

14. The computer program product of claim 11 further comprising computer instructions for:
displaying a search pane that provides an interface for performing a search query on a plurality of electronic communications; and
displaying a results pane that provides an interface for viewing a result of the search query on the plurality of electronic communications.

15. The computer program product of claim 11 further comprising computer instructions for:
displaying a navigation pane that provides an architecture in which references to the at least first electronic communication attribute may be stored.

16. A method for displaying information about at least one electronic communication message, the method comprising:
displaying a first representation of a first electronic communication attribute, associated with the at least one electronic communication, that was derived from the at least one electronic communication; and
displaying a second representation of a second electronic communication attribute, associated with the at least one electronic communication, that was derived from a secondary source.

17. The method of claim 16 wherein the at least one electronic communication is selected from a group consisting of electronic mail, short message service message, instant message, voice message, and video message.

18. The method of claim 16 wherein the second electronic communication attribute is derived from a company employee directory.

19. The method of claim 16 wherein the first and second electronic communication attributes are in the same frame.

20. The method of claim 16 further comprising the steps of:
displaying a search pane that provides an interface for performing a search query on a plurality of electronic communications; and
displaying a results pane that provides an interface for viewing a result of the search query on the plurality of electronic communications.

21. The method of claim 20 wherein the results pane displays at least one electronic communication attribute selected from the group consisting of time, content, participants, threads, and messages.

22. A user interface related to an analysis of an electronic communication message, the user interface comprising:
a representation of at least one attribute corresponding to the electronic communication message;
a dynamic representation, located within the same user interface window, that allows additional details to be viewed for the at least one attribute; and
a pull-down directory, located within the same user interface window, that provides information corresponding to a second electronic communication message related to the first electronic communication message.

23. The user interface of claim 22 wherein the at least one attribute includes an attribute that is derived from a secondary source.

24. The user interface of claim 22 further comprising an interface for annotating text corresponding to the electronic communication message.

25. The user interface of claim 22 wherein the dynamic representation includes a recipients visualization that provides a list of recipients within a mailing list associated with the electronic communication message.

26. The user interface of claim 22 wherein the dynamic representation includes an attachments visualization that provides a list of attachments associated with the electronic communication message.

27. A user interface related to an analysis of an electronic communication thread, the user interface comprising:
a representation of at least one attribute corresponding to the electronic communication thread;
a dynamic representation, located within the same user interface window, that allows additional details to be viewed for the at least one attribute; and
a pull-down directory, located within the same user interface window, that provides information corresponding to an electronic communication message within the electronic communication thread.

28. The user interface of claim 27 further comprising a chart that visualizes a volume of electronic communication messages within the electronic communication thread relative to time.

29. The user interface of claim 28 wherein the chart is a bar chart.

30. The user interface of claim 27 wherein dynamic representation includes a participants visualization that provides a list of participants within the electronic communication thread.

31. The user interface of claim 27 wherein the dynamic representation includes an attachments visualization that provides a list of attachments within the electronic communication thread.

31. A method for displaying information related to an analysis of an electronic communication thread, the method comprising:
displaying a first attribute corresponding to the electronic communications thread;
displaying a chart, within the same user interface as the first attribute, that provides additional information about the first attribute; and
displaying a second attribute corresponding to a message within the electronic communications thread.

32. The method of claim 31, wherein the second attribute was derived from a secondary source.

33. The method of claim 31, wherein the secondary source is a company employee directory.

34. A thread analysis chart corresponding to an analysis of an electronic communication thread, the chart comprising:
a plurality of icons representing a plurality of electronic communication messages within the electronic communication thread;
a visual connection between the plurality of icons; and
a dynamic pop-up window corresponding to at least one icon in the plurality of icons and adapted to provide information related to at least one of the plurality of electronic communication messages.

35. The thread analysis chart of claim 34 wherein a primary electronic communication thread is represented and related electronic communication thread is represented.

36. A user interface related to an analysis of a person associated with an electronic communication message, the user interface comprising:
a representation of a first attribute, derived from the electronic communication message, corresponding to the person;
a representation of a second attribute, derived from a secondary source, corresponding to the person; and
a dynamic representation, located within the same user interface window, that allows additional details to be viewed for the first or second attribute;

37. The user interface of claim 36 wherein the secondary source is a company employee directory.

38. The user interface of claim 36 further comprising an interface for annotating text corresponding to the person.

39. The user interface of claim 36 wherein the dynamic representation includes a names visualization that provides a name for the person and at least one permutation of the name.

40. The user interface of claim 36 wherein the dynamic representation includes an email address visualization that provides an email address for the person and at least one or more alternative email address for the same person.

41. A people analysis chart corresponding to an analysis of a first person associated with at least one electronic communication message, the chart comprising:
a first icon associated with a first person that visually represents at least one characteristic of the at least one electronic communication message; and
a second icon associated with a second person that visually represents at least one characteristic of the at least one electronic communication message; and
wherein a characteristic of the first or the second icon is modified corresponding to a change in the at least one characteristic of the at least one electronic communication message.

42. The people analysis chart of claim 41 wherein the size of the first icon represents a volume associated with the at least one electronic communication message.

43. The people analysis chart of claim 41 further comprising a visual connection between the first and second icons and a thickness of the visual connection represents a volume associated with the at least one electronic communication message.

44. The people analysis chart of claim 41 further comprising a dynamic time line that controls a time period associated with the people analysis chart.

45. The people analysis cart of claim 41 further comprising a third icon associated with a third person that visually represents at least one characteristic of the at least one electronic communication message.
